(19) United States
(12) Patent Application Publication
(10) Pub. No.: US 2007/0224842 A1
(43) Pub. Date: Sep. 27, 2007

(54) Electrical Connector For A Window Pane Of A Vehicle

(75) Inventors: Timothy P. Hoepfner, Grand Ledge, MI (US); Makoto Sato, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: AGC AUTOMOTIVE AMERICAS R&D, INC., Ypsilanti, MI (US)

(21) Appl. No.: 11/755,275

(22) Filed: May 30, 2007

Related U.S. Application Data
(63) Continuation-in-part of application No. 11/619,081, filed on Jan. 2, 2007.
Application No. 11/619,081 is a continuation-in-part of application No. 10/988,350, filed on Nov. 12, 2004, now Pat. No. 7,223,939.

(51) Int. Cl. H01R 33/00

(52) U.S. Cl. 439/34

(57) ABSTRACT

A window pane has a substrate formed from glass and includes an electrical device including an electrical conductor. An electrical connector is operatively connected to and in electrical communication with the conductor for transferring electrical energy to the conductor. An electrical connector is bonded to the electrical conductor and has a first interacting portion. A terminal is disposed adjacent to the electrical connector and has a second interacting portion for interacting with the first interacting portion to mechanically couple the electrical connector and the terminal. The substrate has a first coefficient of thermal expansion and the connector has a second coefficient of thermal expansion. A difference between the first and second coefficients of thermal expansion is equal to or less than 5×10⁻⁶/° C. Due to the mechanical coupling between the connector and the terminal, the terminal and connector are less prone to bending, breakage, or delamination than conventional connector structures.

### RELATED APPLICATIONS

This patent application is a continuation-in-part of and claims priority to and all advantages of U.S. patent application Ser. No. 11/619,081, which was filed on Jan. 2, 2007 and which is a continuation-in-part of and claims priority to an all advantages of U.S. patent application Ser. No. 10/988,350, which was filed on Nov. 12, 2004.

### BACKGROUND OF THE INVENTION

1. Field of the Invention

The subject invention generally relates to a window pane of a vehicle that includes an electrical connector and an electrical conductor. More specifically, the subject invention relates to an electrical connector that transfers electrical energy to an electrical conductor of the window pane, such as a defogger, defroster, antenna, etc.

2. Description of the Related Art

Electrical connectors are known in the art for use in vehicles. The connectors are soldered to and in electrical communication with an electrical conductor for transferring electrical energy to the conductor. More specifically, the conductors, which generally include sintered silver, are bonded to a substrate that is formed from glass, such as a backlite, sidelite, or windshield of a vehicle. The conductors are commonly visible on window panes of vehicles and typically extend horizontally across the window panes. The conductors are generally defoggers, defrosters, and antennas.

Traditionally, the connectors are soldered to the electrical conductors with a lead-based solder because lead is a deformable metal and minimizes mechanical stress between the connector and the substrate due to difference of thermal expansion of the connector and the substrate resulting from changes in temperature. More specifically, differences in coefficients of thermal expansion between the connectors, which are typically made of a good conductive material such as copper, and the substrates cause the mechanical stress. Such stress may result in cracking or other damage to the substrate, which is typically made of glass. Furthermore, the lead decreases the radical reaction rate between tin in the solder and the silver in the conductor, allowing for good solderability. However, it is known that lead may be considered an environmental contaminant. As such, there is a motivation in many industries, including the automotive industry, to move away from all uses of lead in vehicles.

Conventional solder materials have been proposed that replace the lead in the solder with additional tin, along with small amounts of silver, copper, indium and bismuth. However, such materials have increased radical reaction rates between the tin-rich solder and the silver conductor, resulting in poor solderability. These conventional materials do not absorb the mechanical stress between the connector and the substrate due to thermal expansion of the connector and the substrate resulting from changes in temperature, which tends to crack or otherwise damage the substrate. Further, many alternative materials for the connector are difficult to solder, making it difficult to sufficiently adhere the connector to the conductor on the substrate. As a result, other techniques would be required in order to sufficiently adhere the alternative materials to the conductor on the substrate. For example, U.S. Pat. No. 6,253,988 discloses solder compositions including high amounts (or large amounts) of indium due to a low melting point, malleability, and good solderability to the silver. However, solder compositions including indium may have very soft phases, and the solder compositions exhibit poor cohesive strength under stress. Because these other conventional materials are insufficient, there has been little movement in the automotive industry away from soldering the connectors with solder including lead.

Although there has been development of various conductors for use in the window panes of vehicles, such developments have little applicability to electrical connector technology. For example, U.S. Pat. No. 6,396,026 discloses a laminated pane for a vehicle including an electrical conductor disposed between two glass panes. The electrical conductor includes a layered structure that may include titanium to provide rigidity to the electrical conductor. The electrical conductor is positioned in an interlayer between the panes. In this position, the electrical conductor is spaced from the glass panes. The titanium-containing conductor in the '026 patent cannot effectively function as a connector that connects a power supply to a conductor that is bonded to one of the glass panes. More specifically, the titanium is disclosed as a core of the conductor, with an outer surface including a more conductive metal such as copper. The titanium core with the outer surface including copper is ineffective for use as an electrical connector due to the presence of the copper because the copper would delaminate from the conductor and/or cause the glass to crack due to mechanical stress between the copper and the glass pane due to thermal expansion of the copper and the glass pane resulting from changes in temperature.

U.S. Pat. No. 2,644,066 to Glynn provides an electric heater, i.e., an electric conductor, that is disposed on a glass substrate. A metal disc, i.e., an electrical connector, made from a low expansion material is soldered onto the electric heater for supplying electrical power to the electric heater. In terminal areas of the electric heater, a coating of solderable metal is sprayed onto the electric heater because the electric heater is formed from a thin layer of aluminum that is difficult to solder due to its strong surface oxide layer. The electrical connector is connected to the layer of solderable metal through a layer of solder. However, the electrical connector of Glynn is in direct contact with the solder, which is undesirable, especially when the connector is made from materials that are difficult to solder. Further, the solder used in Glynn includes lead, and Glynn does not account for the difficulties that are encountered with traditional solders that do not include lead.

Another deficiency of the electrical connectors of the prior art is in the structure of such connectors themselves. Conventional connector structures include an integral terminal that is easily bent or broken when subjected to force, and may even result in delamination of the whole connector from the substrate when subjected to force. Advances have been made in connectors that have a stronger profile and that are less prone to breakage when subjected to force. For example, button-type connectors for attachment to electrical conductors on vehicle windows are known in the art, examples of which are illustrated by a series of patents assigned to Antaya Technologies Corporation and cited in the present application. The button-type connectors include a cylindrical post, i.e., a terminal, and a base, i.e., an electrical connector. The base is soldered to an electrical conductor on a substrate, such as glass, and the cylindrical post is mechanically coupled to the base. More specifically, the cylindrical post includes a lip that extends from the terminal, and the base includes a sleeve that extends from a body of the base with the lip of the terminal disposed in the sleeve. A distal end of the sleeve is crimped against the lip to mechanically couple the cylindrical post and the base. Such a connection allows for a lower profile of the connector than with the integral connectors, allows for some play between the cylindrical post and the base, and lowers stress concentration as compared to other configurations for connectors. As a result, the connector is less prone to bending and breakage when subjected to force. However, the base and the cylindrical post are both formed from conventional electrically-conductive materials, such as copper, that have excessive differences in coefficients of thermal expansion with the substrate. As a result, the substrate is still prone to cracking or other damage due to thermal expansion of the base and the substrate resulting from changes in temperature, especially when lead-free solders are used to solder the base onto the electrical conductor on the substrate.

Thus, there remains a need to provide connectors that may be bonded to the conductor through a layer of solder, that may be soldered with solders that do not include lead, that can still reduce the mechanical stress between the connector and the substrate due to thermal expansion of the connector and the substrate resulting from changes in temperature, and that are less prone to bending, breakage, or delamination than conventional connector structures that include an integral terminal.

### SUMMARY OF THE INVENTION AND ADVANTAGES

The subject invention provides a window pane. The window pane includes a substrate. The subject invention also provides an electrical device for a window pane, and a vehicle including the window pane. The window pane includes an electrical conductor applied across a region of the substrate. An electrical connector is bonded to the electrical conductor and has a first interacting portion. A terminal is disposed adjacent to the electrical connector and has a second interacting portion for interacting with the first interacting portion to mechanically couple the electrical connector and the terminal. Due to the mechanical coupling between the connector and the terminal, the terminal is less prone to bending, breakage, or delamination than conventional connector structures that include an integral terminal. Also, since the terminal and connector are mechanically coupled, a low stress concentration is also achievable between the connector and the terminal.

The substrate has a first coefficient of thermal expansion and the connector has a second coefficient of thermal expansion. A difference between the first and second coefficients of thermal expansion is equal to or less than 5×10⁻⁶/° C. for minimizing mechanical stress between the connector and the substrate due to thermal expansion of the connector and the substrate resulting from changes in temperature. As a result, the connector resists delamination from the substrate. Non-conventional electrically-conductive materials are used for the connector to attain the desired difference in coefficient of thermal expansion between the connector and the substrate. Due to the mechanical coupling between the connector and the terminal, less of the non-conventional electrically-conductive materials may be used than in conventional connector structures that include the integral terminal. This is due, in part, to the fact that the mechanical coupling allows play between the connector and the terminal, thus rendering differences in coefficient of thermal expansion between the connector and the terminal immaterial such that conventional electrically-conductive materials can be used for the terminal. Further, the non-conventional electrically-conductive materials are typically expensive, and costs are reduced by using less of the non-conventional electrically-conductive materials. Further still, lower electrical resistance may be achieved by using less of the non-conventional electrically-conductive materials, which often have high electrical resistance. Further still, the mechanical coupling provides an easier mode of manufacture as compared to integral configurations of connectors and terminals that use of different materials for the connector and the terminal.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a vehicle including a rear window pane having an electrical device;

FIG. 2 is a view of the window pane of FIG. 1 with a power supply schematically illustrated;

FIG. 2a is a partial view a portion of the window pane of FIG. 2;

FIG. 3 is a partial cross-sectional perspective view of the window pane of FIG. 2 illustrating an electrical connector of the present invention and a terminal with the electrical connector and the terminal mechanically coupled together;

FIG. 4 is a schematic cross-sectional side view of the window pane taken along line 4-4 in FIGS. 2a and 3 illustrating the electrical conductor bonded to a ceramic layer, which is bonded to a substrate;

FIG. 5 is a schematic cross-sectional side view of another embodiment of the window pane illustrating the electrical conductor bonded to the substrate absent the ceramic layer;

FIG. 6 is a cross-sectional side view of the electrical connector and the terminal mechanically coupled together; and

FIG. 7 is a top view of the electrical connector and the terminal of FIG. 6.

### DETAILED DESCRIPTION OF THE PREFERRED EMBODIMENT

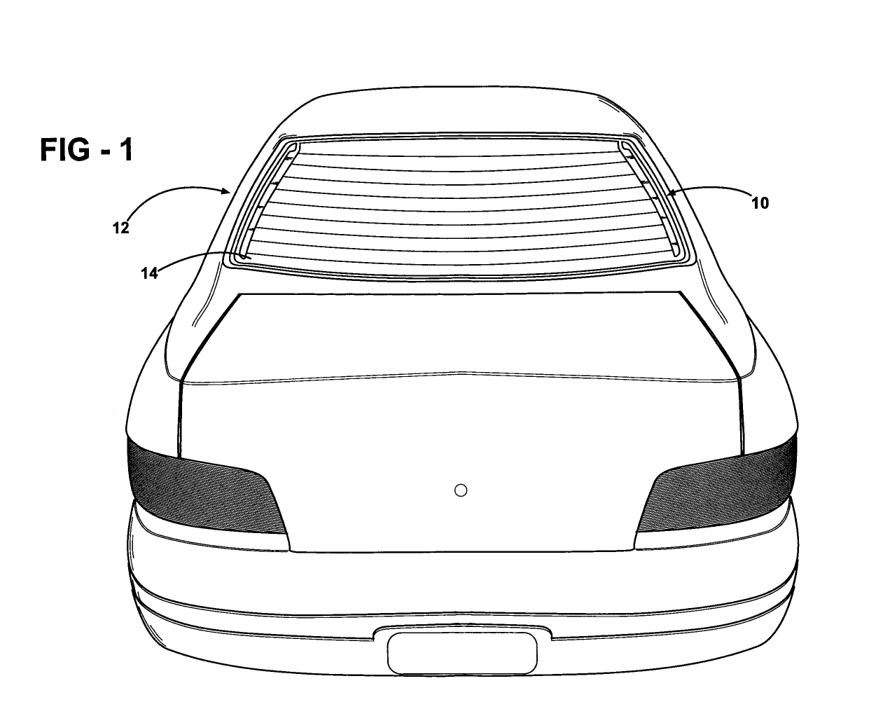

Referring to the FIGS., wherein like numerals indicate like or corresponding parts throughout the several views, a window pane is generally shown at 10 on a vehicle 12 in FIG. 1. The window pane 10 includes a substrate 14 that has a first coefficient of thermal expansion. The present invention also provides an electrical device 24 for a window pane 10 having a substrate 14, with the electrical device 24 disposed on the substrate 14. Further, the present invention provides the vehicle 12 including the window pane 10.

Preferably, the substrate 14 is formed from glass; however, the substrate 14 may be formed from other materials such as ceramic. More preferably, the glass is further defined as an automotive glass. In a most preferred embodiment, the automotive glass is further defined as soda-lime-silica glass, which is well known for use in window panes 10 of vehicles 12. However, it is to be appreciated that the glass may be any type of glass composition that is known in the art.

An electrical conductor 16 is applied across a region of the substrate 14. Preferably, the conductor 16 includes silver; however, it is to be appreciated that other conductive metals may also be suitable for the conductor 16. The electrical conductor 16 is visible on the pane 10 and typically includes lines 18 that extend horizontally across the pane 10. The conductor 16 is preferably a defogger, defroster, antenna, or a combination thereof. However, the conductor 16 may serve any function known in the art for such conductors 16.

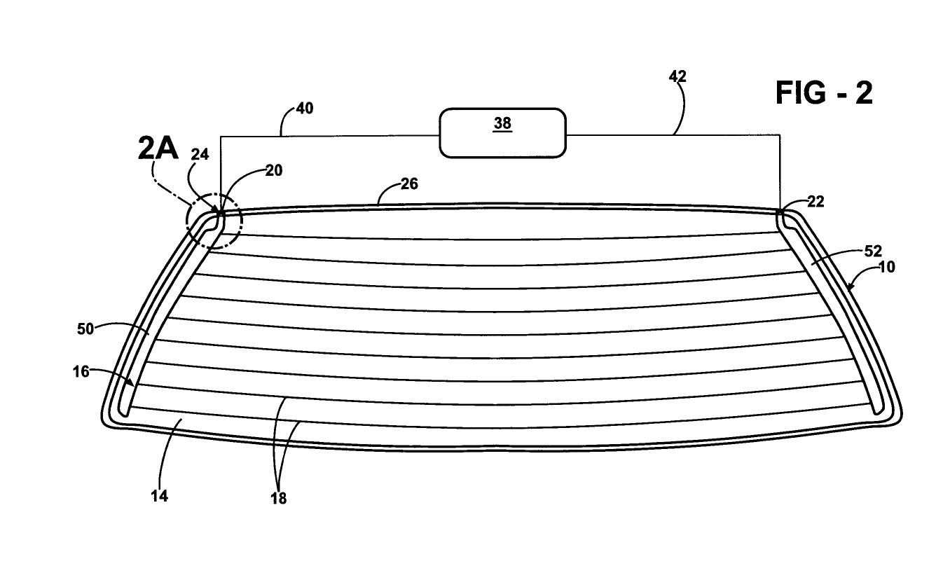

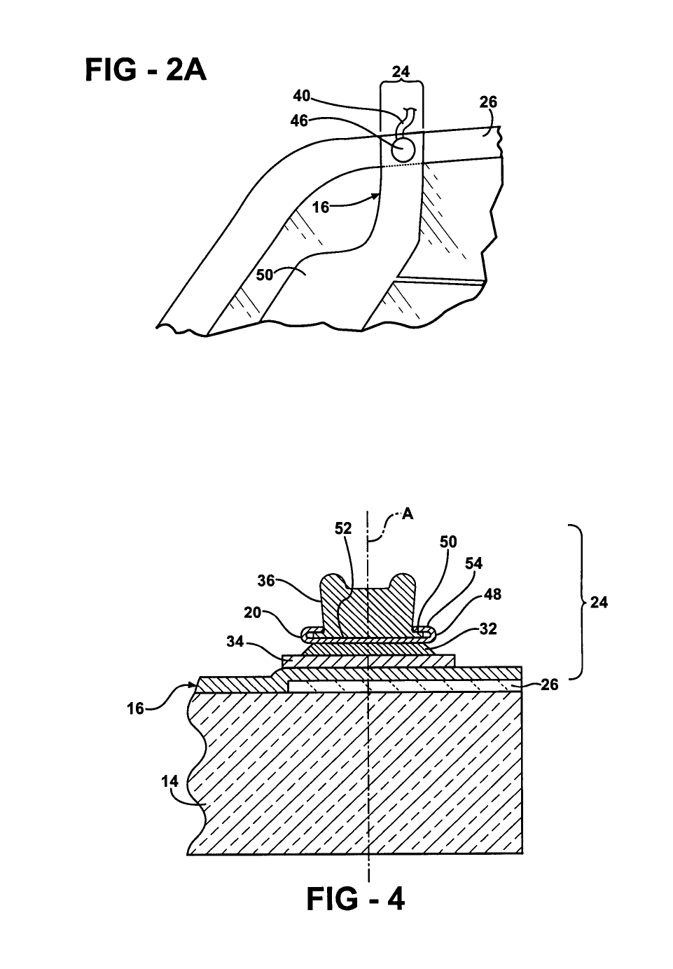

Referring to FIGS. 2 through 5, the window pane 10 further includes an electrical connector 20 and a terminal 36. The electrical connector 20 and the terminal 36 are mechanically coupled, as described in further detail below. The primary purpose of the terminal 36 is to provide a site for connection to a lead wire 40, as described in further detail below, while the primary purpose of the electrical connector 20 is to provide a site for connection to the electrical conductor 16 while sufficiently matching a coefficient of thermal expansion with the substrate 14 to prevent cracking and delamination of the electrical connector 20 from the substrate 14.

The electrical connector 20 has a second coefficient of thermal expansion. It is to be appreciated that the first interacting portion 48 is typically an integral part of the connector 20, and the materials used for the connector 20 are also present in the first interacting portion 48. The connector 20 (and first interacting portion 48) include a metal having a low coefficient of thermal expansion (CTE). By “low coefficient of thermal expansion” it is meant that the metal has a sufficiently low CTE to make the difference between the first coefficient of thermal expansion of the substrate 14 and the second coefficient of thermal expansion of the connector 20 less than or equal to 5×10⁻⁶/° C., more typically less than or equal to 4×10⁻⁶/° C., most typically less than or equal to 3×10⁻⁶/° C. Preferably, the connector 20 and the first interacting portion 48 include titanium; however other metals including, but not limited to, iron, molybdenum, tungsten, hafnium, tantalum, chromium, iridium, niobium, vanadium, platinum, and combinations thereof, as well as low CTE alloys such as iron-nickel alloys and titanium alloys, may be suitable for the connector 20 so long as a difference between the first coefficient of thermal expansion of the substrate 14 and the second coefficient of thermal expansion of the connector 20 is less than or equal to 5×10⁻⁶/° C., which will be described in further detail below. The titanium enables the connector 20 to reduce mechanical stress between the connector 20 and the substrate 14 due to thermal expansion of the connector 20 and the substrate 14 resulting from changes in temperature. More specifically, the mechanical stress is caused by differences between the first and second coefficients of expansion. The mechanical stress may cause cracking or other damage to the substrate 14, and may also cause the connector 20 to separate from the substrate 14.

Preferably, the titanium is present in the connector 20 and the first interacting portion 48 in an amount of at least 50 parts by weight based on 100 parts by weight of the connector 20. In a more preferred embodiment, the titanium is present in an amount of at least 85 parts by weight, most preferably 99 parts by weight, based on 100 parts by weight of the connector 20. A composition comprising 99 parts by weight of titanium based on 100 parts by weight of the composition is considered commercially pure titanium. In the most preferred embodiment, a remainder of the connector 20 may include iron, oxygen, carbon, nitrogen, and/or hydrogen, each of which may be present in an amount of less than or equal to 0.2 parts by weight based on 100 parts by weight of the connector 20. Other residual elements may also be present in the connector 20 in an amount of less than 0.4 parts by weight based on 100 parts by weight of the connector 20.

In another embodiment, the titanium may be an alloyed titanium that is alloyed with a metal selected from the group of aluminum, tin, copper, molybdenum, cobalt, nickel, zirconium, vanadium, chromium, niobium, tantalum, palladium, ruthenium, and combinations thereof. In this other embodiment, the metal is preferably present in the connector 20 in a total amount of from 0.05 to 50 parts by weight, more preferably from 1 to 10 parts by weight, most preferably from 1 to 5 parts by weight, based on 100 parts by weight of the connector 20.

The titanium, as well as the solder composition that is typically free of lead (to be described in further detail below), is environmentally-friendly, and minimizes harmful effects to the environment to a greater extent than many other materials that are commonly used in connectors and solder compositions. Thus, waste tracking and disposal of excess titanium and solder composition from the manufacturing process and the processing of broken panes 10 is less stringent than for more environmentally harmful materials.

Besides environmental considerations, another advantage of the presence of titanium in the connector 20 is that the titanium has a substantially similar coefficient of thermal expansion to the substrate 14, as briefly discussed above. Referring to FIG. 4, although the connector 20 and the substrate 14 may not be directly connected, i.e., the conductor 16, optionally the layer of solderable metal 32, and optionally the layer of solder 34 are disposed between the substrate 14 and the connector 20, the substrate 14, which has the first coefficient of thermal expansion, is rigid and prone to cracking when subjected to mechanical stress resulting from expansion and contraction of the connector 20 due to changes in temperature. Preferably, the conductor 16 has a relatively small thickness from 4×10⁻⁶ to 20×10⁻⁶ m, as compared to the connector 20, which typically has a thickness from 0.2×10⁻³ to 2×10⁻³ m. As a result of the small thickness and silver content of the conductor 16, the conductor 16 is malleable or deformable and deforms when subjected to mechanical stress resulting from expansion and contraction of the conductor 16 due to changes in temperature. Thus, the conductor 16 absorbs much of the mechanical stress due to changes in temperature. However, the connector 20 also expands and contracts due to the changes in temperature, which also results in mechanical stress that is absorbed by the conductor 16. As a result, substantial differences between the first and second coefficients of thermal expansion result in excessive mechanical stress on the conductor 16 and the substrate 14. The substrate 14 is generally more brittle than both the connector 20 and the conductor 16 and cracks due to the mechanical stress.

As set forth above, a difference between the first and second coefficients of thermal expansion is equal to or less than 5×10⁻⁶/° C., taken as an average over the temperature range of from 0 to 300° C., which is sufficient to avoid cracking of the substrate 14 up to and including a temperature of 600° C. Preferably, the first coefficient of thermal expansion is from 8 to 9×10⁻⁶/° C. As mentioned above, the substrate is preferably soda-lime-silica glass, which has a coefficient of thermal expansion of from 8.3 to 9×10⁻⁶/° C., most preferably about 8.3×10⁻⁶/° C., also taken as an average over a temperature range of from 0 to 300° C. Preferably, the second coefficient of thermal expansion is from 3 to 13×10⁻⁶/° C., most preferably about 8.8×10⁻⁶/° C., taken as average over the temperature range of from 0 to 300° C.

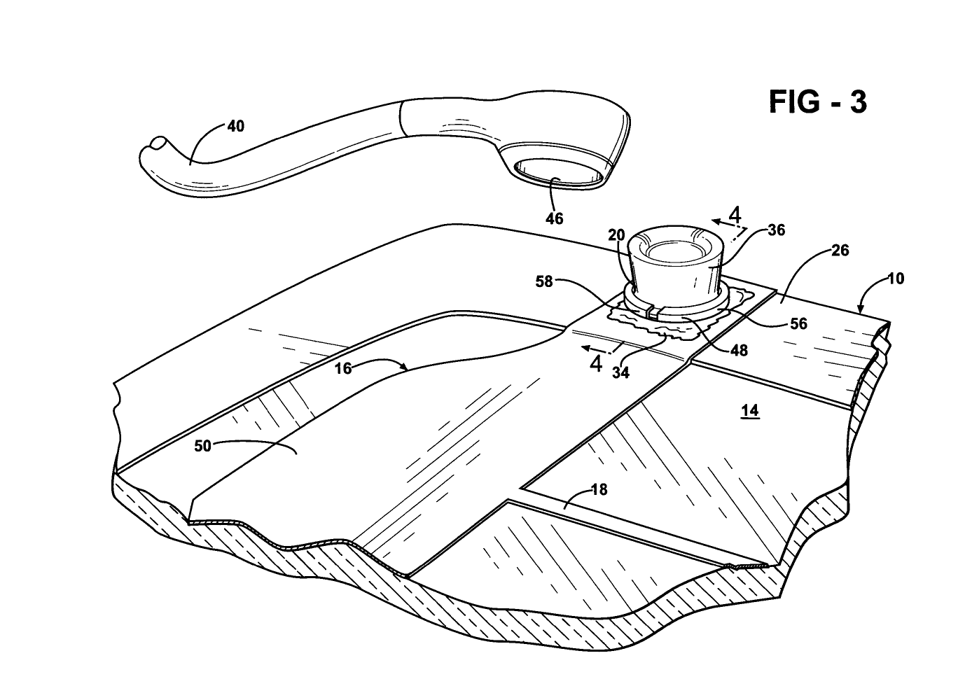

Referring to FIGS. 3 through 7, the electrical connector 20 has a first interacting portion 48, which is best described in conjunction with the physical features of the terminal 36. The terminal 36 is disposed adjacent to the electrical connector 20 and has a second interacting portion 50 for interacting with the first interacting portion 48 of the electrical connector 20. The interaction between the first interacting portion 48 and the second interacting portion 50 functions to mechanically couple the electrical connector 20 and the terminal 36. By “interacting” portion, it is meant that the portion is used to physically contact another portion to accomplish mechanical coupling. By “mechanical coupling”, it is meant that the electrical connector 20 and the terminal 36 are permanently connected together through physical structures, as opposed to metallurgically or chemically bonding to each other. The physical structures prevent the electrical connector 20 and the terminal 36 from separating from each other.

Typically, the second interacting portion 50 of the terminal 36 is further defined as a lip 50 that extends from the terminal 36 transverse to an axis A passing through both the terminal 36 and the electrical connector 20. The terminal 36 is typically cylindrical in shape; however, it is to be appreciated that the terminal 36 may have different shapes. As another point of reference, the axis A passes through a longitudinal center of the cylindrical shape, and the lip 50 is typically continuous around a perimeter of the cylindrical shape of the terminal 36. The continuous nature of the lip 50 enables the lip 50 to function as the second interacting portion 50 regardless of a degree of rotation of the terminal 36 with respect to the electrical connector 20 and the first interacting portion 48, as described in further detail below, and prevents separation of the electrical connector 20 and the terminal 36. However, it is to be appreciated that in other embodiments, the lip 50 may be interrupted around the perimeter of the cylindrical shape of the terminal 36. The lip 50 is typically located at an end of the terminal 36 that is adjacent to and that typically abuts the electrical connector 20, which enables the terminal 36 to be mechanically coupled to the electrical connector 20.

Typically, the first interacting portion 48 of the electrical connector 20 is further defined as a sleeve 48 that extends from a body 52 of the electrical connector 20. When the terminal 36 and the electrical connector 20 are mechanically coupled, the lip 50 is disposed in the sleeve 48. At least a portion of a distal end 54 of the sleeve 48 encases the lip 50 for preventing the lip 50 from exiting the sleeve 48. The distal end 54 of the sleeve 48, as referred to herein, is spaced from the body 52 of the electrical connector 20. The portion of the distal end 54 that encases the lip 50 essentially wraps around the lip 50 and prevents the lip 50 from exiting, or moving out of, the sleeve 48. To encase the lip 50, the portion of the distal end 54 may be crimped against the lip 50. Typically, the lip 50 is in contact with at least one of the body 52 and the portion of the distal end 54 that encases the lip 50, i.e., the lip 50 may be loosely disposed between the body 52 and the portion of the distal end 54 that encases the lip 50 so long as the lip 50 is prevented from exiting the sleeve 48.

The shape of the sleeve 48 typically corresponds to the shape of the terminal 36. For example, when the terminal 36 is cylindrical in shape, the sleeve 48 may also be cylindrical in shape. However, the terminal 36 preferably has a smaller diameter than the sleeve 48 such that the terminal 36, and the lip 50 extending from the terminal 36, may fit into the sleeve 48. When the lip 50 is continuous around the perimeter of the terminal 36, the sleeve may comprise two opposing sections 56, 58, as shown in FIGS. 3 and 7, that face each other, with gaps separating the two opposing sections 56, 58 for enabling the distal end 54 of each opposing section to be bent around the lip 50 and to thereby encase the lip 50.

The sleeve 48 of the electrical connector 20 is formed from the same material as the rest of the electrical connector 20, which materials are described in detail above. The terminal 36, including the cylindrical shape as well as the lip 50, may be formed from conventional electrically-conductive materials that preferably have a lower resistance than the connector 20, such as copper, plated copper, or brass. The mechanical coupling between the electrical connector 20 and the terminal 36 allows play between the connector 20 and the terminal 36, thus rendering differences in coefficient of thermal expansion between the connector 20 and the terminal 36 immaterial such that the conventional electrically-conductive materials can be used for the terminal 36 without buildup of stress therebetween. When the electrical connector 20 includes titanium, the electronic conductivity of the electrical connector 20 is typically higher than the electrical conductivity of the terminal 36, which results in greater heat generation than typically occurs in similar electrical connectors formed from conventional electrically-conductive materials, such as copper. However, heat generation is typically lower than when an electrical connector 20 is used without the terminal 36 because the terminal 36 functions to provide a site for connection to the lead wire 40. Further, due to the use of the terminal 36, and because the terminal 36 may be formed from the conventional electrically-conductive materials, costs are reduced by minimizing the amount of material that would otherwise be required for the electrical connector 20 absent the terminal 36 as described herein. Absent the terminal 36, connection to the lead wire 40 would have to be accomplished with the electrical connector 20 itself, thus requiring more titanium or other material having a high resistivity (or low conductivity) and thereby generating more heat.

The electrical connector 20 is bonded to the electrical conductor 16. More specifically, as shown in FIG. 4, a layer of solderable metal 32 is typically bonded to the connector 20. The bond between the layer of solderable metal 32 and the connector 20 is typically a mechanical bond and/or a metallic bond and may be established by any known process including, but not limited to, cladding, sputtering, electroplating, or vacuum plating solderable metal onto the connector 20.

The layer of solderable metal 32 may include any type of solderable metal that is capable of bonding to the connector 20 to establish the bond between the layer of solderable metal 32 and the connector 20, and that further provides a binding site that exhibits excellent adhesion to the layer of solder 34. Preferably, the solderable metal is capable of bonding to titanium. Typically, the solderable metal is selected from the group of copper, zinc, tin, silver, gold, and combinations thereof.

A layer of solder 34 is typically bonded to the layer of solderable metal 32 and the conductor 16 with the connector 20 and the conductor 16 in electrical communication through the layer of solderable metal 32 and the layer of solder 34. As such, the electrical connector 20 is typically bonded to the electrical conductor 16 through both the layer of solderable metal 32 and the layer of solder 34. Alternatively, the layer of solder 34 may be bonded directly to the electrical connector 20, in the absence of the layer of solderable metal 32. Typically, the layer of solder 34 is bonded to the layer of solderable metal 32 and the conductor 16 by soldering. While the use of the layer of solder 34 is preferred, it is to be appreciated that the electrical connector 20 can be metallurgically bonded directly to the electrical conductor 16 through known welding techniques such as laser welding, ultrasonic welding, friction welding, etc. Together, the conductor 16, optionally the layer of solder 34, optionally the layer of solderable metal 32, the connector 20, and the terminal 36 form the electrical device 24. However, it is to be appreciated that the layer of solderable metal 32 and the layer of solder 34, although preferably present, may be absent from the electrical device 24.

When used, the layer of solder 34 is formed from a solder composition. The solder composition typically includes tin and a reaction rate modifier, and is typically free of lead. The reaction rate modifier in the solder composition improves bonding between the conductor 16 and the layer of solderable metal 32, as opposed to solder compositions that do not include the reaction rate modifier, and also serves the purpose of replacing at least a portion of the tin in the solder composition. Tin generates a compound with silver, such as the silver that may be in the conductor 16, that helps form a strong bond between the layer of solder 34 and the conductor 16. If the solder composition does not include a certain amount of lead, this reaction is too radical and silver at the surface of the conductor 16 dissolves into the solder immediately, resulting in poor solderability and delamination between the layer of solder 34 and the conductor 16. By including the reaction rate modifier in the solder composition instead of lead, the radical reaction may be suppressed and solderability improved in a way that is similar to when lead is included in the solder composition. The reaction rate modifier is typically a low-melting point metal, and may be selected from the group of, but is not limited to, bismuth, indium, zinc, and combinations thereof.

The reaction rate modifier is typically present in the solder composition in an amount of from 30 to 90 parts by weight based on 100 parts by weight of the solder composition. Most preferably, the reaction rate modifier is present in the solder composition in an amount of from 40 to 60 parts by weight, based on 100 parts by weight of the solder composition. The tin is typically included in the solder composition in an amount of from 10 to 70 parts by weight, most preferably from 25 to 50 parts by weight, based on 100 parts by weight of the solder composition. In addition to the tin and reaction rate modifier, the solder composition may also include other metals including, but not limited to, silver, copper, and combinations thereof for providing durability to the solder composition. When present, the silver may be included in an amount of equal to or less than 5 parts by weight based on 100 parts by weight of the solder composition. The copper may be included in an amount of equal to or less than 5 parts by weight based on 100 parts by weight of the solder composition, independent of the amount of silver included in the solder composition.

When present, the layer of solderable metal 32 and the layer of solder 34 typically have a combined thickness that is sufficiently small to eliminate any effect of differences in coefficient of thermal expansion between the layer of solderable metal 32, the layer of solder 34, the connector 20, and the substrate 14. More specifically, the layer of solderable metal 32 and the layer of solder 34 typically have a combined thickness of less than or equal to 3.0×10⁻⁴ m, based on experimental results, which is sufficiently small to render the coefficient of thermal expansion of both the layer of solderable metal 32 and the layer of solder 34 immaterial, especially when the connector 20 has a thickness as great as 2×10⁻³ m. Due to the combined thickness of the layer of solderable metal 32 and the layer of solder 34 of less than or equal to 3.0×10⁻⁴ m, and the position of the layer of solderable metal 32 and the layer of solder 34 between two relatively stiff materials, i.e., the connector 20 and the substrate 14, the layer of solderable metal 32 and the layer of solder 34 will deform during heating and cooling instead of transmitting thermal expansion mismatch stress to the substrate 14.

It is to be appreciated that the electrical device 24 of the present invention may include the connector 20, the terminal 36, optionally the layer of solderable metal 32, optionally the layer of solder 34, and the conductor 16, to the exclusion of the substrate 14. More specifically, the electrical device 24 exists separate from the substrate 14, and the electrical device 24 need not necessarily be incorporated in conjunction with the window pane 10.

Besides silver, the conductor 16 may also include other materials such as glass frit and flow modifiers. The conductor 16 is applied to the substrate 14 as a paste, which is subsequently fired onto the substrate 14 through a sintering process. More specifically, after the paste is applied to the substrate 14, the substrate 14 is subjected to a low temperature bake at about 200° C., which causes the flow modifiers to flash out of the paste. The substrate 14 is then subjected to sintering at about 650° C., which fires the paste onto the substrate 14 to form the conductor 16. The sintering process also prevents mechanical stress from developing between the conductor 16 and the substrate 14.

When the conductor 16 is a defroster or defogger, the conductor 16 may further include vertical strips 50, 52, in addition to the lines 18, disposed on opposite ends of the lines 18. The strips 50, 52 electrically connect the lines 18. The strips 50, 52, in combination with the lines 18, form a parallel circuit.

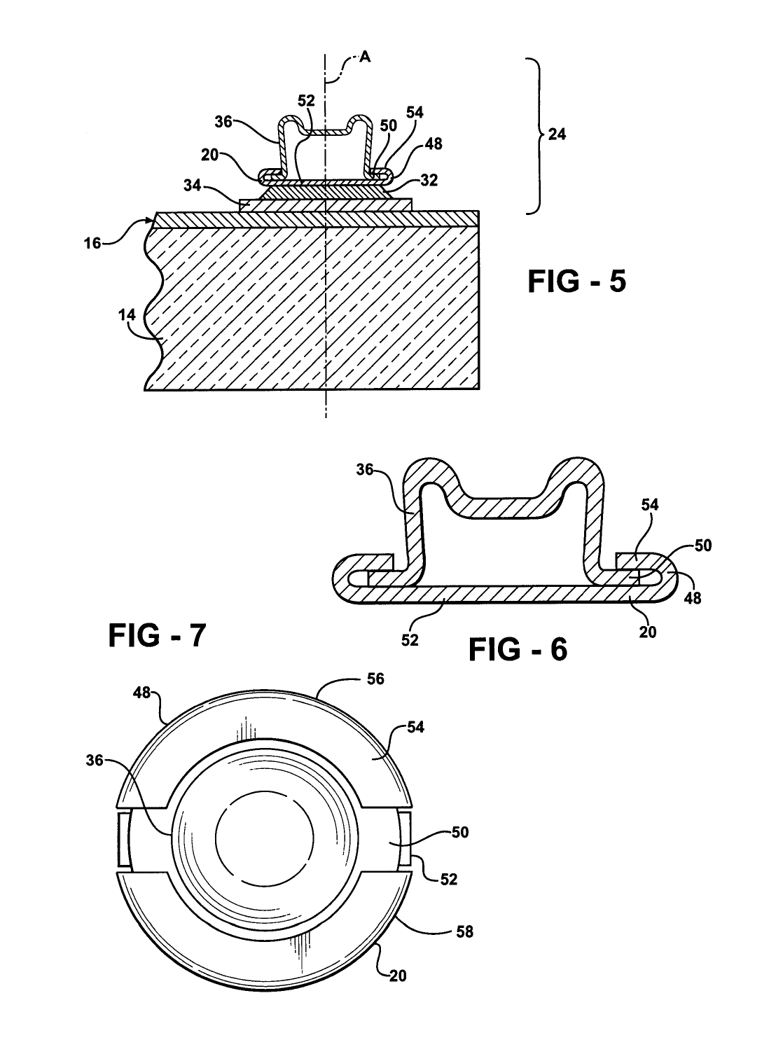

Referring to FIGS. 2 and 4, the pane 10 may include a ceramic layer 26 disposed adjacent to a periphery of the pane 10. The ceramic layer 26 protects an adhesive on the substrate 14 from UV degradation. As known in the art, such adhesive is typically utilized to adhere the pane 10 to a body of the vehicle 12. Thus, as shown in FIG. 4, the ceramic layer 26 may be disposed between the substrate 14 and the conductor 16. The ceramic layer 26 is generally black in color and has a negligible effect on the thermal expansion dynamics between the substrate 14, the conductor 16, and the connector 20. Thus, in terms of thermal expansion dynamics, there is no significant difference between the configuration as shown in FIG. 4, wherein the connector 20 is bonded to the conductor 16 on top of the ceramic layer 26, and the configuration as shown in FIG. 5, wherein the connector 20 is bonded to the conductor 16 on top of the substrate 14.

The connector 20 transfers electrical energy to the conductor 16. Typically, the connector 20 is connected to the conductor 16, optionally through the layer of solderable metal 32 and the layer of solder 34, adjacent the periphery of the pane 10 on one side of the pane 10. Preferably, a second connector 22 is bonded to and in electrical communication with the conductor 16, also optionally through a layer of solderable metal 32 and a layer of solder 34, on an opposite side of the pane 10 from the connector 20. The second connector 22 may transfer electrical energy away from the conductor 16. When present, the second connector 22 also includes a second terminal 36, and the second connector 22 and the second terminal 36 are mechanically coupled in the same manner as set forth above for the electrical connector 20 and the terminal 36. However, it is to be appreciated that the second connector 22 is optional, for example in the case of an antenna, which typically requires a single connector 20.

In one embodiment, as shown schematically in FIG. 2, the vehicle 12 includes the power supply 38 for providing the electrical energy. The power supply 38 may be a battery, alternator, etc. Preferably, both the connector 20 and the second connector 22 are operatively connected to and in electrical communication with the power supply 38. More specifically, the connector 20 and the second connector 22 are operatively connected to the power supply 38 through the respective first and second terminals 36. The connector 20 transfers electrical energy from the power supply 38 to the conductor 16, through the layer of solderable metal 32 and the layer of solder 34, and the second connector 22 transfers electrical energy from the conductor 16, through the second terminal 36, to the power supply 38. More specifically, the lead wire 40 is operatively connected to and extends from the power supply 38 adjacent to the substrate 14. The lead wire 40 is also operatively connected to the terminal 36. A second lead wire 42 extends from the power supply 38 to the second terminal 36 and is operatively connected to the second terminal 36 to complete an electrical circuit. The lead wire 40 and the second lead wire 42 preferably include copper.

The operative connection between the lead wire 40 and the terminal 36 is typically a mechanical connection. Typically, the lead wire 40 includes a female member 46 for receiving the terminal 36, which is essentially a male member. As set forth above, the terminal 36 is typically cylindrical in shape. Referring to FIGS. 4-6, the cylindrical shape of the terminal 36 typically has a variable diameter, with an end of the terminal 36 spaced from the connector 20 having a greater diameter than the end of the terminal 36 that is adjacent to the connector 20. The variable diameter of the cylindrical shape provides a button-type configuration to the operative connection between the lead wire 40 and the terminal 36, with the female member 46 snapping over the end of the terminal 36 and engaging the terminal 36 through compression to prevent separation between the female member 46 of the lead wire 40 and the terminal 36. However, it is to be appreciated that the lead wire 40 and the terminal 36 may be connected through welding or other processes. The operative connection between the second connector 22 and the second lead wire 42 may be the same as the operative connection between the connector 20 and the lead wire 40.

### EXAMPLES

Test plaques were made including the glass substrate 14, the electrical conductor 16, the electrical connector 20 including the layer of solderable metal 32, and the layer of solder 34. Half of the test plaques include glass substrates 14 with a ceramic layer 26, and the electrical conductor 16 was bonded to the glass substrate 14 over the ceramic layer 26. However, the results were the same for both configurations with and without the ceramic layer 26 present. The electrical conductor 16 was formed from silver paste for all of the plaques, and the silver paste was fired onto the substrate 14 to form the electrical conductor 16. The layer of solderable metal 32 was formed on the connector 20 by vacuum ion plating. The connector 20 was soldered to the conductor 16 through the layer of solder 34. The electrical connector 20, the layer of solderable metal 32, and the layer of solder 34 were formed from metals as indicated in Table 1. The glass substrate 14 was formed from soda-lime-silica

Further, the connectors soldered to the plaques were subjected to a pull test at least 24 hours after soldering. Referring to Table 1, the type and amount of metal used for the connector 20, the layer of solderable metal 32, and the layer of solder 34 are shown for each of the plaques, with amounts in parts by weight based on 100 parts by weight of the connector 20, the layer of solderable metal 32, or the layer of solder 34, respectively, along with an indication of whether or not the plaque exhibits sufficient performance when subjected to changes in temperature. Furthermore, the properties of the soda-lime-silica glass are also included in the Table 1.

TABLE 1

| | Material | Ex. A | Ex. B |
|---|---|---|---|
| Electrical | Titanium | 100.00 | 100.00 |
| Connector | Avg. CTE, ×10⁻⁶/° C. over range of 0-100° C. | 8.80 | 8.80 |
| | Difference between CTE of Connector | 0.5 | 0.5 |
| | and Glass Substrate, ×10⁻⁶/° C. over a | | |
| | range of 0-100° C. | | |
| | Thickness of Electrical Connector, m | 8.0 × 10⁻⁴ | 8.0 × 10⁻⁴ |
| Layer of | Copper | 100.00 | 100.00 |
| Solderable metal | Thickness of Layer of Solderable Metal, m | 5.0 × 10⁻⁶ | 5.0 × 10⁻⁶ |
| Layer of solder | Tin | 48 | 34 |
| | Bismuth | 46 | 60 |
| | Silver | 2 | 2 |
| | Copper | 4 | 4 |
| | Thickness of Layer of Solder, m | 50-200 × 10⁻⁶ | 50-200 × 10⁻⁶ |
| | Combined Thickness of Layer of | 55-205 × 10⁻⁶ | 55-205 × 10⁻⁶ |
| | Solderable Metal and Layer of Solder, m | | |
| Glass Substrate | Avg CTE, ×10⁻⁶/° C. over range of 0-302° C. | 8.3 | 8.3 |
| (Soda-Lime- | Results of Pull Test | Good Pull | Good Pull |
| Silica) | | Strength | Strength |

### Comparative Examples

Comparative Examples of plaques are made for comparison to the plaques made in accordance with the present invention. More specifically, plaques for Comparative Examples B thru E were made the same as set forth above in the Examples, except for the amount of reaction rate modifier used and the thickness of the layer of solderable metal. Comparative Example A was made using copper for the electrical connector instead of titanium. In Comparative Example C, no layer of solderable metal is present. Referring to Table 2, the type and amount of metal used for the connector and the layer of solder are shown for each of the plaques, with amounts in parts by weight based on 100 parts by weight of the connector or the layer of solder, respectively, along with an indication of whether or not the plaque exhibits sufficient performance when subjected to changes in temperature. Furthermore, the properties of the soda-lime-silica glass are also included in the Table 2.

TABLE 2

| | | Comp. | Comp. | Comp. |
|---|---|---|---|---|
| | Material | Ex. A | Ex. B | Ex. C |
| Electrical | Copper | 100.00 | 0.00 | 0.00 |
| Connector | Titanium | 0.00 | 100.00 | 100.00 |
| | Avg. CTE, ×10⁻⁶/° C. over range of | 17.1 | 8.8 | 8.8 |
| | 0-100° C. | | | |
| | Difference between CTE of | 8.8 | 0.5 | 0.5 |
| | Connector and Glass Substrate, | | | |
| | ×10⁻⁶/° C. over a range of 0-100° C. | | | |
| | Thickness of Electrical Connector, m | 8.0 × 10⁻⁴ | 8.0 × 10⁻⁴ | 8.0 × 10⁻⁴ |
| Layer of | | | | None |
| Solderable | | | | |
| metal | | | | |
| | Copper | 0.00 | 100.00 | 0.00 |
| | Thickness of Layer of Solderable | 0.00 | 500 × 10⁻⁶ | 0.00 |
| | Metal, m | | | |
| Layer of | Tin | 48 | 48 | 48 |
| solder | Bismuth | 46 | 46 | 46 |
| | Silver | 2 | 2 | 2 |
| | Copper | 4 | 4 | 4 |
| | Thickness of Layer of Solder, m | 50-200 × 10⁻⁶ | 50-200 × 10⁻⁶ | 50-200 × 10⁻⁶ |
| | Combined Thickness of Layer of | 50-200 × 10⁻⁶ | 550-700 × 10⁻⁶ | 50-200 × 10⁻⁶ |
| | Solderable Metal and Layer of | | | |
| | Solder, m | | | |
| Glass | Avg CTE, ×10⁻⁶/° C. over range of | 8.3 | 8.3 | 8.3 |
| Substrate | 0-302° C. | | | |
| (Soda-Lime- | Results of Elevated Temperature | Substrate | Substrate | No |
| Silica) | Test | cracks, | cracks, | adhesion |
| | | Poor pull | Poor pull | |
| | | strength | strength | |

| | | Comp. | Comp. |
|---|---|---|---|
| | Material | Ex. D | Ex. E |
| Electrical | Titanium | 100.00 | 100.00 |
| Connector | Avg. CTE, ×10⁻⁶/° C. over range of 0-100° C. | 8.80 | 8.80 |
| | Difference between CTE of Connector and Glass | 0.5 | 0.5 |
| | Substrate, ×10⁻⁶/° C. over a range of 0-100° C. | | |
| | Thickness of Electrical Connector, m | 8.0 × 10⁻⁴ | 8.0 × 10⁻⁴ |
| Layer of | Copper | 100.00 | 100.00 |
| Solderable | Thickness of Layer of Solderable Metal, m | 5.0 × 10⁻⁶ | 5.0 × 10⁻⁶ |
| metal | | | |
| Layer of | Tin | 90 | 48 |
| solder | Bismuth | 7.5 | 46 |
| | Silver | 2.0 | 2 |
| | Copper | 0.5 | 4 |
| | Thickness of Layer of Solder, m | 50-200 × 10⁻⁶ | 400-500 × 10⁻⁶ |
| | Combined Thickness of Layer of Solderable | 55-205 × 10⁻⁶ | 405-505 × 10⁻⁶ |
| | Metal and Layer of Solder, m | | |
| Glass | Avg CTE, ×10⁻⁶/° C. over range of 0-302° C. | 8.3 | 8.3 |
| Substrate | Results of Elevated Temperature Test | Poor | Substrate |
| (Soda-Lime- | | solderability, | cracks, |
| Silica) | | Poor | Poor pull |
| | | pull | strength |
| | | strength | |

Obviously, many modifications and variations of the present invention are possible in light of the above teachings. It is, therefore, to be understood that within the scope of the appended claims, the invention may be practiced otherwise than as specifically described.

What is claimed is:

1. A window pane comprising:
a substrate formed from glass and having a first coefficient of thermal expansion;
an electrical conductor applied across a region of said substrate;
an electrical connector bonded to said electrical conductor and having a second coefficient of thermal expansion with a difference between said first and second coefficients of thermal expansion equal to or less than 5×10⁻⁶/° C., said electrical connector having a first interacting portion; and
a terminal disposed adjacent to said electrical connector and having a second interacting portion for interacting with said first interacting portion to mechanically couple said electrical connector and said terminal.

2. A window pane as set forth in claim 1 wherein said second interacting portion is further defined as a lip extending from said terminal transverse to an axis passing through said terminal and said electrical connector.

3. A window pane as set forth in claim 2 wherein said first interacting portion is further defined as a sleeve extending from a body of said electrical connector with said lip of said terminal disposed in said sleeve.

4. A window pane as set forth in claim 3 wherein at least a portion of a distal end of said sleeve spaced from said body encases said lip for preventing said lip from exiting said sleeve.

5. A window pane as set forth in claim 4 wherein said lip is in contact with at least one of said body and said portion of said distal end.

6. A window pane as set forth in claim 5 wherein said portion of said distal end is crimped against said lip.

7. A window pane as set forth in claim 3 wherein said sleeve and said terminal are both cylindrical in shape with said terminal having a smaller diameter than said sleeve.

8. A window pane as set forth in claim 7 wherein said lip is continuous around a perimeter of said cylindrical shape of said terminal.

9. A window pane as set forth in claim 7 wherein said cylindrical shape of said terminal has a variable diameter with an end of said terminal spaced from said connector having a greater diameter than an end of said terminal adjacent to said connector.

10. A window pane as set forth in claim 3 wherein said electrical connector and said sleeve comprise titanium.

11. A window pane as set forth in claim 1 wherein said second coefficient of thermal expansion is from 3 to 13×10⁻⁶/° C.

12. A window pane as set forth in claim 1 wherein said first coefficient of thermal expansion is from 8 to 9×10⁻⁶/° C.

13. A window pane as set forth in claim 1 wherein said connector and said first interacting portion comprise at least one of titanium, molybdenum, tungsten, hafnium, tantalum, chromium, iridium, niobium, platinum, and vanadium.

14. A window pane as set forth in claim 1 wherein said connector and said first interacting portion comprise a low CTE alloy.

15. A window pane as set forth in claim 1 wherein said connector and said first interacting portion comprise titanium.

16. A window pane as set forth in claim 15 wherein said titanium is present in said connector and said first interacting portion in an amount of at least 50 parts by weight based on 100 parts by weight of said connector.

17. A window pane as set forth in claim 16 wherein said titanium is present in said connector and said first interacting portion in an amount of at least 85 parts by weight based on 100 parts by weight of said connector.

18. A window pane as set forth in claim 15 wherein said titanium is alloyed with a metal selected from the group of aluminum, tin, copper, molybdenum, cobalt, nickel, zirconium, vanadium, chromium, niobium, tantalum, palladium, ruthenium, and combinations thereof.

19. A window pane as set forth in claim 18 wherein said metal is present in an amount of from 0.05 to 50 parts by weight based on 100 parts by weight of said connector.

20. A window pane as set forth in claim 1 wherein said connector and said first interacting portion comprise a nickel-iron alloy.

21. A window pane as set forth in claim 1 wherein said terminal comprises a conventional electrically-conductive material.

22. A window pane as set forth in claim 1 further comprising a layer of solderable metal bonded to said connector.

23. A window pane as set forth in claim 22 further comprising a layer of solder bonded to said layer of solderable metal and said conductor with said connector and said conductor in electrical communication through said layer of solderable metal and said layer of solder.

24. A window pane as set forth in claim 23 wherein said layer of solderable metal and said layer of solder have a combined thickness of less than or equal to 3.0×10⁻⁴ m.

25. A window pane as set forth in claim 1 wherein said conductor comprises silver.

26. A window pane as set forth in claim 1 further comprising a ceramic layer disposed between said substrate and said conductor.

27. A window pane as set forth in claim 1 wherein said glass is further defined as automotive glass.

28. A window pane as set forth in claim 27 wherein said glass is further defined as soda-lime-silica glass.

29. A window pane as set forth in claim 1 wherein said conductor is selected from the group of defoggers, defrosters, antennas, and combinations thereof.
